(19) United States
(12) Patent Application Publication
(10) Pub. No.: US 2022/0325677 A1
(43) Pub. Date: Oct. 13, 2022

(54) ADJUSTABLE EXHAUST NOZZLE FOR DETONATION ENGINES

(71) Applicant: Detonation Space Inc., Hollywood, CA (US)

(72) Inventors: Ümit Yelken, Istanbul (TR); Mehmet Emre Taskin, Istanbul (TR)

(21) Appl. No.: 17/228,682

(22) Filed: Apr. 12, 2021

(51) Int. Cl. F02K 1/12; F02C 5/00

(52) U.S. Cl. CPC F02K 1/1207; F02C 5/00

(57) ABSTRACT

A rotating detonation engine can include an annular combustion chamber, an adjustable exhaust nozzle, and a nozzle actuator arrangement. The annular combustion chamber can have repetitive high frequency combustion and can include an outlet. The nozzle can be coupled to that outlet to receive exhaust reactants expelled therefrom. The nozzle can include elongated fins arranged in a conical shape having inner surfaces, outer surfaces, and distal ends. The fins can include outer and inner sets of fins, can contract toward a closed position, and can expand toward an open position. Distal ends of the fins can define a nozzle outlet having variable diameters. The nozzle actuator arrangement can have fin adjusters that adjust the fins between the closed and open positions when power is applied to a power transmitter coupled to the fin adjusters during engine operations.

### TECHNICAL FIELD

The present disclosure relates generally to detonation engines, and more particularly to rotating detonation engines having exhaust nozzle structures.

### BACKGROUND

Detonation engines are based on pressure gain combustion where shockwaves increase pressure and temperature on a fuel/air mixture during a combustion process. Common detonation engine types include pulse detonation engines and rotating detonation engines. Pulse detonation engines involve ongoing combustion impulses that are interrupted, which is limiting since a single detonation wave is essentially an isolated or “frozen” event for practical purposes, while rotating detonation engines provide continuous thrust due to the combustion impulses for these engines being effectively continuous in an ongoing detonation wave. Rotating detonation engines typically have an annulus shaped combustion chamber, operate at supersonic speeds, and provide continuous thrust at high operating frequencies of over 1000 Hz due to rapid sequential propagating detonation. Reactants are continuously fed into a rotating detonation combustion chamber from inlets, whereupon detonators ignite the reactants to result in a continuously circulating detonation wave around the annulus of the combustion chamber.

Reactions produced by shock waves in a detonation engine generate thrust force, the effects of which can vary depending on ambient air conditions. In the case of a rocket or aircraft, for example, a change in altitude can result in a change in ambient air pressure. This pressure change can in turn alter thrust force conditions. Where a detonation engine uses an exhaust nozzle structure, these changes in thrust force conditions can result in changing effects at the exhaust nozzle structure.

Unfortunately, existing geometries for exhaust nozzle structures of detonation engine systems can effectively limit their applications. For example, some detonation engine systems utilize a convergent-divergent shaped exhaust nozzle. Such a geometry can account for exhaust conditions at a particular altitude and shape the convergent-divergent nozzle such that exhaust effects are optimized at that particular altitude. This can then result in less than optimal exhaust effects at other altitudes through. There are presently no known exhaust nozzle geometries or arrangements that can optimize exhaust effects and thus engine thrust over a range of changing ambient air pressures due to altitude changes in continuous operation.

Although traditional exhaust nozzles for detonation engines have worked well in the past, improvements are always helpful. In particular, what is desired are improved exhaust nozzle arrangements for detonation engines that account for changes in altitude and other ambient conditions during continuous use of the detonation engine.

### SUMMARY

It is an advantage of the present disclosure to provide improved exhaust nozzle arrangements for detonation engines that account for changes in altitude and other ambient conditions during continuous use of the detonation engine. The disclosed features, apparatuses, systems, and methods provide detonation engine exhaust nozzle solutions that involve improvements to exhaust nozzle shape and functionality over varying operational conditions of the associated detonation engines, such as altitude changes during rocket flight. In particular, a detonation engine exhaust nozzle arrangement can have an outlet that is adjustable during engine operations, such that optimal outlet size can be obtained over a range of different altitudes. These advantages can be accomplished in multiple ways, such as by implementing an exhaust nozzle arrangement having fins that define the shape of the nozzle, which fins can expand and contract as desired to result in changes to the shape of the nozzle and its outlet size.

In various embodiments of the present disclosure, a rotating detonation engine can include an annular combustion chamber, an adjustable exhaust nozzle, and a nozzle actuator arrangement. The annular combustion chamber can be configured for the repetitive high frequency combustion of fuel and oxidizer reactants, and can include an internal region, an exterior, an inlet and an outlet. The adjustable exhaust nozzle can be coupled to the outlet of the annular combustion chamber and configured to receive exhaust reactants expelled from the annular combustion chamber. The adjustable exhaust nozzle can include a plurality of elongated fins arranged in a conical shape and having inner surfaces, outer surfaces, first distal ends, and second distal ends. The plurality of elongated fins can be operable to contract toward a closed position and expand toward an open position, where the first distal ends of the elongated fins define a circular exhaust nozzle outlet having a first diameter at the closed position and a second diameter at the open position, the first diameter being smaller than the second diameter. The nozzle actuator arrangement can be coupled to the plurality of elongated fins and can include one or more fin adjusters coupled to at least one power transmitter. The one or more fin adjusters can be configured to adjust the plurality of elongated fins between the closed position and the open position when power is applied to the at least one power transmitter and during operation of the rotating detonation engine.

In various detailed embodiments, the plurality of elongated fins can include an inner set of fins located within an outer set of fins. The inner and outer sets of fins can contract toward the closed position together and expand toward the open position together, and the inner set of fins can cover expanding gaps between the outer set of fins when the outer set of fins expands toward the open position. The plurality of elongated fins can further include one or more intermediary sets of fins between the inner set of fins and outer set of fins. The reactants expelled from the annular combustion chamber can follow a flow path along the inner surfaces of the fins from the annular combustion chamber to the circular exhaust nozzle outlet.

In various detailed embodiments, the one or more fin adjusters can include a plurality of push rods having first ends and second ends. Each of the push rods can be coupled at its first end to one of the elongated fins and at its second end to the power transmitter. The first end of each of the push rods can be coupled to one of the elongated fins proximate its second distal end. In some arrangements, rotational movement of the power transmitter can result in corresponding movements in all of the push rods which results in all of the elongated fins being collectively contracted or expanded. In some arrangements, lateral movement of the power transmitter can result in corresponding movements in all of the push rods which results in all of the elongated fins being collectively contracted or expanded.

In various further detailed embodiments, the adjustable exhaust nozzle and nozzle actuator arrangement can be formed from materials configured to withstand temperatures up to 3000° C. and forces up to 50 kN without deforming. Such materials can be selected from the group consisting of Iconcel, steel, and ceramic. In addition, the elongated fins can be operable to contract or expand toward any position between the closed position the open position to result in a plurality of possible circular exhaust nozzle outlet diameters between the first diameter and the second diameter.

In still further detailed embodiments, the rotating detonation engine can also include one or more sensors coupled to at least one processor. The sensor(s) can be configured to detect the altitude of the rotating detonation engine, the ambient air pressure outside the rotating detonation engine, or both. The at least one processor can be configured to receive data from the sensor(s) and control the power transmitter in response to the received data. Corresponding control of the power transmitter can adjust the diameter of the circular exhaust nozzle outlet according to the altitude of the rotating detonation engine, the ambient air pressure outside the rotating detonation engine, or both.

In various further embodiments of the present disclosure, an exhaust nozzle configured for use in a detonation engine can include a circular exhaust nozzle inlet, a circular exhaust nozzle outlet, and a plurality of elongated fins. The circular exhaust nozzle inlet can be coupled to an outlet of an annular combustion chamber in the detonation engine, and the circular exhaust nozzle inlet can be configured to receive exhaust reactants expelled from the annular combustion chamber. The circular exhaust nozzle outlet can be configured to expel exhaust reactants from the exhaust nozzle and expelling the exhaust reactants can provide thrust to the detonation engine. The plurality of elongated fins can be arranged in a conical shape and can have inner surfaces, outer surfaces, first distal ends, and second distal ends. The elongated fins can be operable to contract toward a closed position and expand toward an open position. The first distal ends of the elongated fins can combine to define the circular exhaust nozzle outlet and the second distal ends of the elongated fins can combine to define the circular exhaust nozzle inlet. The circular exhaust nozzle outlet can have a first diameter at the closed position and a second diameter at the open position, the first diameter being smaller than the second diameter.

In various detailed embodiments, the plurality of elongated fins can include an inner set of fins located within an outer set of fins. The inner and outer sets of fins can contract toward the closed position together and expand toward the open position together, and the inner set of fins can cover expanding gaps between the outer set of fins when the outer set of fins expands toward the open position. The plurality of elongated fins can further include one or more intermediary sets of fins between the inner set of fins and outer set of fins. In addition, the exhaust reactants expelled from the annular combustion chamber can follow a flow path along the inner surfaces of the elongated fins from the annular combustion chamber to the circular exhaust nozzle outlet.

Other apparatuses, methods, features, and advantages of the disclosure will be or will become apparent to one with skill in the art upon examination of the following figures and detailed description. It is intended that all such additional apparatuses, methods, features and advantages be included within this description, be within the scope of the disclosure, and be protected by the accompanying claims.

### BRIEF DESCRIPTION OF THE DRAWINGS

The included drawings are for illustrative purposes and serve only to provide examples of possible structures and arrangements for the disclosed apparatuses, systems and methods for adaptive exhaust nozzles for combustion engines. These drawings in no way limit any changes in form and detail that may be made to the disclosure by one skilled in the art without departing from the spirit and scope of the disclosure.

FIG. 1 illustrates in rear cross-section view an example combustion chamber of a rotating detonation engine according to one embodiment of the present disclosure.

FIG. 2A illustrates in side elevation view a rotating detonation engine having an adjustable exhaust nozzle in a closed position according to one embodiment of the present disclosure.

FIG. 2B illustrates in side elevation view the rotating detonation engine of FIG. 2A with the adjustable exhaust nozzle in an open position according to one embodiment of the present disclosure.

FIG. 3A illustrates in rear perspective view an adjustable exhaust nozzle in a closed position according to one embodiment of the present disclosure.

FIG. 3B illustrates in rear perspective view the adjustable exhaust nozzle of FIG. 3A in an open position according to one embodiment of the present disclosure.

FIG. 4 illustrates in rear perspective view an inner set of elongated fins and combined actuator arrangement for the adjustable exhaust nozzle of FIG. 3A according to one embodiment of the present disclosure.

FIG. 5 illustrates in rear perspective view an outer set of elongated fins and combined actuator arrangement for the adjustable exhaust nozzle of FIG. 3A according to one embodiment of the present disclosure.

FIG. 6 illustrates in side perspective view a single inner elongated fin and actuator for an adjustable exhaust nozzle according to one embodiment of the present disclosure.

FIG. 7 illustrates in side perspective view a single outer elongated fin and actuator for an adjustable exhaust nozzle according to one embodiment of the present disclosure.

### DETAILED DESCRIPTION

Exemplary applications of apparatuses, systems, and methods according to the present disclosure are described in this section. These examples are being provided solely to add context and aid in the understanding of the disclosure. It will thus be apparent to one skilled in the art that the present disclosure may be practiced without some or all of these specific details provided herein. In some instances, well known process steps have not been described in detail in order to avoid unnecessarily obscuring the present disclosure. Other applications are possible, such that the following examples should not be taken as limiting. In the following detailed description, references are made to the accompanying drawings, which form a part of the description and in which are shown, by way of illustration, specific embodiments of the present disclosure. Although these embodiments are described in sufficient detail to enable one skilled in the art to practice the disclosure, it is understood that these examples are not limiting, such that other embodiments may be used, and changes may be made without departing from the spirit and scope of the disclosure.

The present disclosure relates in various embodiments to features, apparatuses, systems, and methods for providing and using improved rotating detonation engines having adjustable exhaust nozzles. In particular, the disclosed embodiments provide improved geometries and adjustable outlet size for exhaust nozzles of rotating detonation engines over a range of varying ambient conditions, which can maximize thrust and enable the detonation engines to work more efficiently at different altitudes, such as in the case of rocket or aircraft.

Rotating detonation engines have combustion chambers shaped like a ring. Impulse forces that occur in these combustion chambers result from the chemical reactions that occur therein and can be transmitted from the combustion chambers to associated exhaust nozzles. The engines can then move by using the reaction forces generated against inner surfaces of the exhaust nozzles, resulting in overall thrust. Exhaust nozzle shapes and surfaces are important in terms of meeting and directing this thrust, as well as for the overall stability and safety of the overall rotating detonation engine and any associated system.

When utilizing exhaust nozzles to obtain thrust, is generally well-known that ideal thrust efficiency can be obtained when pressure at the exhaust nozzle outlet is equal to the external ambient pressure outside the engine. Where internal combustion forces and temperatures can be modeled and the external ambient pressure is known, the exhaust nozzle geometry and the size of the exhaust nozzle outlet will then determine whether this equalizing condition is met. In situations where exhaust nozzles having a constant size, shape and geometry are used, the exact dimensions of the exhaust nozzle outlet can be set to match the primary or most anticipated operational conditions of the overall engine. The constant nature of the exhaust nozzle outlet can be less than optimal, however, for any varied operational condition, such as a change in altitude, for example.

In order to increase the efficiency of the exhaust nozzles used in these engines then, it can be preferable to have exhaust outlets that are adjustable, such that the exhaust outlet size can be adjusted to correspond to varied operational conditions. In various arrangements provided in the present disclosure, this can be accomplished using exhaust nozzles formed by expanding and contracting elongated fins, such that expansion or contraction of the elongated fins then adjusts the size of the exhaust outlet of the nozzle. Such expansion or contraction can take place during operation of the engine, such that changes in altitude of the overall detonation engine can be accounted for on an ongoing basis by adjusting the elongated fins to in turn adjust the exact size of the exhaust outlet to match the current operating conditions.

Although various embodiments disclosed herein discuss rotating detonation engines, it will be readily appreciated that the disclosed features, apparatuses, systems, and methods can similarly be used for any relevant combustion engine having an exhaust nozzle. For example, the disclosed adjustable exhaust nozzles may also be used for pulse detonation engines, gas turbine combustion chambers, and other combustion engines. Alternative dimensions, shapes, cross-sections, fin arrangements, and actuator arrangements may also be used for such adaptive exhaust nozzles. Other applications, arrangements, and extrapolations beyond the illustrated embodiments are also contemplated.

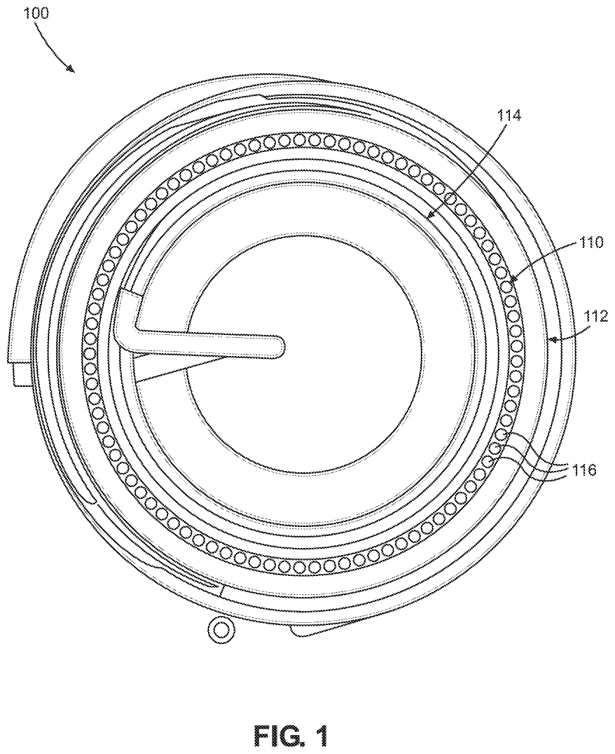

Referring first to FIG. 1, an example combustion chamber of a rotating detonation engine is illustrated in rear cross-section view. Rotating detonation engine 100 can include a combustion chamber 110 having an outer surface 112 and an inner surface 114. Combustion chamber 110 can be designed for continuous rotational movement as flammable reactants (e.g., fuel and oxidizer) are sprayed from various injectors 116 distributed around a circumference of the combustion chamber. Combustion of the flammable reactants can create a continuous shock wave that is fed with continuous further flammable reactants in an appropriate mixture ratio. The flammable reactant ratios and types that can be used in this mixture may vary, and can include, for example, liquid oxygen/kerosene, liquid oxygen/hydrogen, or air/hydrogen among other mixture possibilities. Continuous combustion of the flammable reactant feed results in thrust, as the combusted and expanded reactant products move from high pressure to low pressure and exit the combustion chamber 110 in a direction perpendicular to the plane of FIG. 1, where these spent reactant products can then enter an exhaust nozzle (not shown).

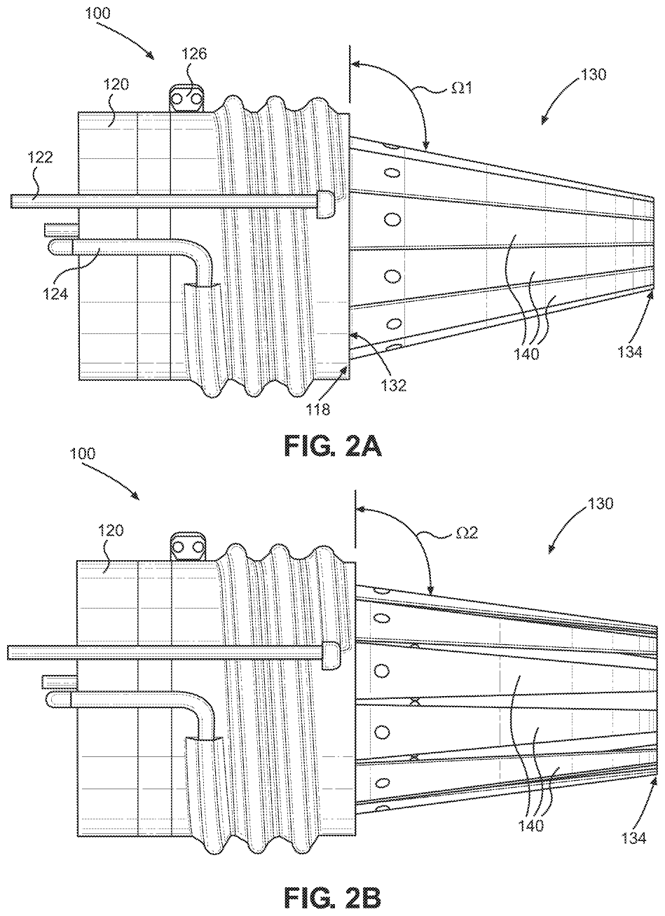

Moving next to FIGS. 2A and 2B, a rotating detonation engine having an adjustable exhaust nozzle is shown in side elevation views in closed and open positions respectively. Rotating detonation engine 100 is shown in FIG. 2A with exhaust nozzle 130 in a closed position configuration, while rotating detonation engine configuration 100 is shown in FIG. 2B with exhaust nozzle 130 in an open position configuration. In both configurations, a stationary outer housing 120 can contain the combustion chamber (not shown) therein, with the outlet position 118 of the combustion chamber feeding directly to an inlet position 132 of exhaust nozzle 130. As such, exhaust nozzle 130 can be coupled directly to the outlet of the combustion chamber. Both configurations of the rotating detonation engine 100 can also include additional stationary components, such as a fuel feed 122, oxidizer feed 124, and pre-detonator 126.

Exhaust nozzle 130 can include a plurality of elongated fins 140 that are arranged in a conical shape and are configured to contract and expand to adjust the size of the exhaust nozzle outlet 134. Both exhaust nozzle inlet 132 and exhaust nozzle outlet 134 can have circular cross-sections through which expended reactants and gases flow. The diameter of exhaust nozzle inlet 132 can remain fixed, and the diameter of exhaust nozzle outlet 134 can be varied during engine use. Exhaust nozzle outlet 134 can be at a minimum size when elongated fins 140 are fully contracted as shown in the closed position of FIG. 2A, while exhaust nozzle outlet 134 is at a maximum size when elongated fins 140 are fully expanded as shown in the open position of FIG. 2B. Various other sizes of the exhaust nozzle outlet 134 between these minimum and maximum sizes are also possible, such as when elongated fins 140 are partially contracted or expanded.

In various arrangements, elongated fins 140 can form an angle Ω with respect to the outlet position 118 of the combustion chamber. A maximum angle Ω1 can be formed when the elongated fins 140 are fully contracted as shown in FIG. 2A, while a minimum angle Ω2 can be formed with the elongated fins are fully expanded as shown in FIG. 2B. This angle Ω can be increased or decreased during engine operations, thus enabling an effective use of exhaust nozzle outlet pressure against various ambient conditions, such as external pressure, altitude, gravity, temperature, and the like. As will be readily appreciated, changes in angle Ω can result in changes to the cross-sectional area of the exhaust nozzle outlet, which then results in changes to the exhaust pressure and resulting thrust from the engine. In some arrangements, these changes to angle can Ω ensure that the outlet pressure at the end of the nozzle is equal to the atmospheric pressure for optimal thrust conditions. Alternatively, these changes can result in a different exit pressure as may be desired. In any event, changing angle Ω can cause a corresponding increase or decrease in the efficiency of the overall engine, with such efficiency being derived from the relationship between atmospheric pressure, altitude, and combustion conditions. In various embodiments, angle Ω can be adjusted between 90 and 180 degrees, for example, and such changes can depend on the length of the elongated fins, engine thrust, altitude, ambient external pressure, and nozzle actuator arrangement forces, among other factors.

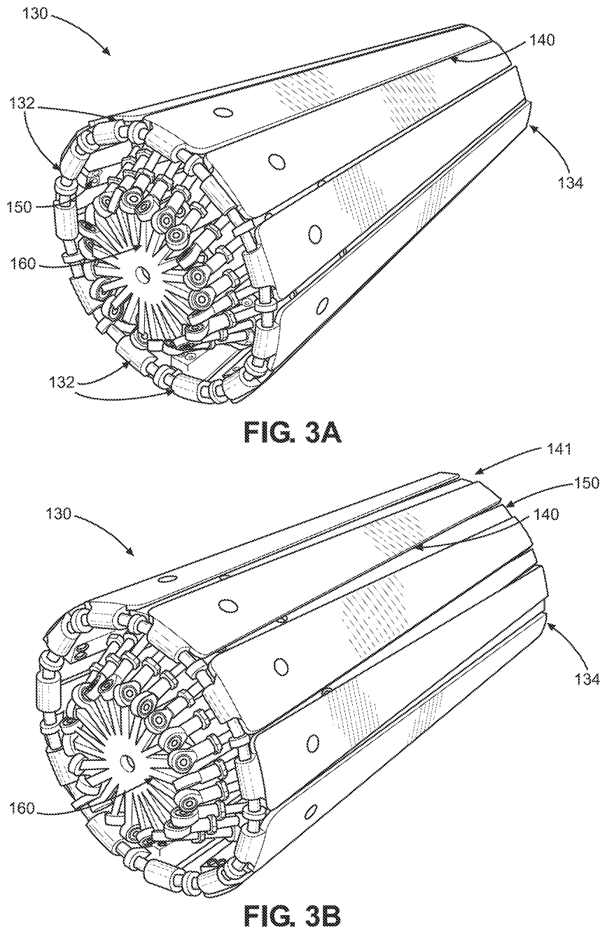

Continuing with FIGS. 3A and 3B an adjustable exhaust nozzle is illustrated in rear perspective views in closed and open positions respectively. In various arrangements, exhaust nozzle 130 can be fixed to the body of the engine, such as proximate the outlet of the combustion chamber (not shown), by bolt and nut connection, rivet, tight fit, cold forming, welding, or other attachment techniques. The diameter of the connection between exhaust nozzle 130 and the engine body may vary depending on various engine dimensions, such as the diameter of the combustion chamber outlet, for example. Combustion chamber outlet diameters can vary between 50-750 mm, for example, and the diameter of exhaust nozzle inlet 132 can be set to reflect the exact dimensions of the rest of the engine. In one specific example, the diameter of exhaust nozzle inlet 132 can be about 125 mm.

Again, the diameter of exhaust nozzle outlet 134 can be changed continuously during operation of the engine depending on various factors, such as altitude. In one specific example, the diameter of exhaust nozzle outlet 134 can be about 53 mm when the exhaust nozzle 130 is in the fully closed position shown in FIG. 3A. This diameter of exhaust nozzle outlet 134 can then grow larger as the elongated fins 140 of the exhaust nozzle 130 are expanded, such as to the fully open position shown in FIG. 3B. In any event, the maximum diameter of exhaust nozzle outlet 134 should not be larger than the diameter of the exhaust nozzle inlet 132. Of course, the actual sizes of the exhaust nozzle inlet 132 and exhaust nozzle outlet 134 can be different according to the dimensions of other engine components. In various arrangements, a nozzle actuator arrangement 160 can be used to expand and contract elongated fins 140, as detailed below.

As will be appreciated, high temperatures and pressures can exist throughout exhaust nozzle 130 during normal engine operations, especially at exhaust nozzle outlet 134. As such, the various components of exhaust nozzle should be able to withstand temperatures ranging from 900−3000° C. and forces of up to 50 kN without deformation in this temperature range. Any uncontrolled shape changes or material failure during engine operations can be catastrophic for the overall engine, such that the materials used to form exhaust nozzle 130 can be important. In various embodiments, materials used to form the components of exhaust nozzle 130 can include, for example, Inconel, stainless steel, ceramic, or composite materials. Other materials can also be included for additional purposes, such as adding or mixing one or more aluminum items to increase thermal conductivity and thereby increase cooling abilities.

In various embodiments, elongated fins 140 can be an outer set of fins. As this outer set of elongated fins expands, gaps 141 can form between each elongated fin 140, as shown in the fully open configuration of FIG. 3B. Such gaps 141 are not conducive to proper nozzle function, since spent reactants and gases can then escape laterally through the gaps causing much turbulence and disruption due to an improper alternative exhaust outlet path. Accordingly, multiple sets of contracting and expanding elongated fins can be used. For example, an inner set of fins 150 can be located just beneath outer set of fins 140. Inner set of fins 150 can be positioned such that these fins cover the gaps 141 that form between the outer set of fins 140 as this outer set of fins expands. The inner set of fins 150 and outer set of fins 140 can contract toward an overall closed position together and expand toward an overall open position together and can combine to form an effective conical shape for the overall exhaust nozzle 130 regardless of the contracted or expanded position of all fins. In various embodiments, one or more intermediary sets of fins (not shown) can be located between the inner set of fins and outer set of fins. Such intermediary set(s) of fins can be used in similar fashion to cover similar gaps between the inner set of fins 150 as this set of fins expands.

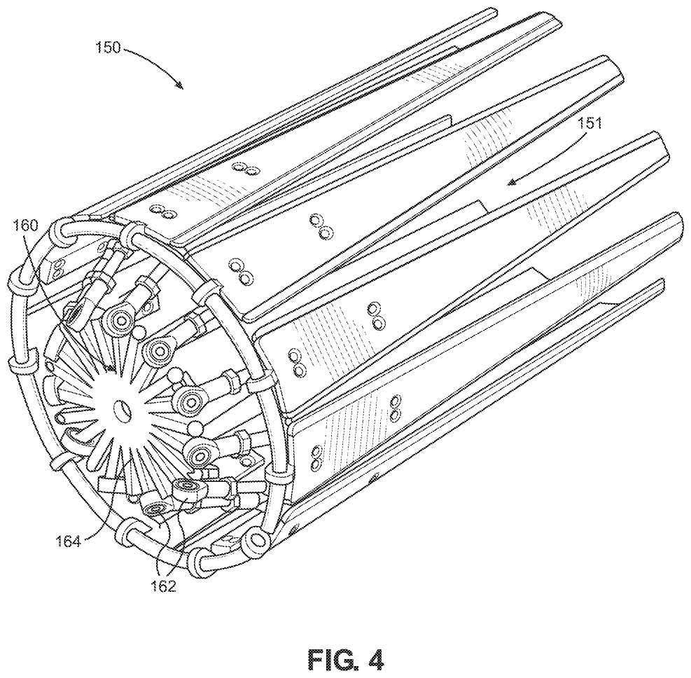

FIG. 4 illustrates in rear perspective view an inner set of fins and combined nozzle actuator arrangement for the adjustable exhaust nozzle of FIG. 3A. Inner set of fins 150 is shown in fully open or expanded position and can include multiple fins as may be desired for a given design. In various embodiments, the number of elongated fins can vary between 2 and 36 fins. As a specific example, eleven elongated fins can be used for inner set of fins 150. Similar to outer set of fins 140 above, gaps 151 can form between the elongated fins as the inner set of fins 150 expands. Depending on particular geometries and arrangements, gaps 151 can be covered by the elongated fins of a corresponding outer set of fins (not shown). Alternatively, one or additional intermediary sets of fins (not shown) can be used to cover gaps 151, with each set of fins being similarly adapted to contract and expand together with the other sets of fins.

In various embodiments, elongated fin lengths can vary between 80-500 mm. As a specific example, the length of each elongated fin in inner set of fins 150 can be about 197 mm. The width of each elongated fin in inner set of fins 150 can depend on the number of fins. As the number of fins increases, the width of each fin can correspondingly decrease. Conversely, as the number of fins decreases, the width of each fin should increase. In various embodiments, elongated fin widths can vary between 4-250 mm. As can be seen, each elongated fin can be tapered, such that the width of each fin decreases from a first distal end located at the exhaust nozzle inlet toward a second distal end located at the exhaust nozzle outlet. As a specific example, the width of each elongated fin in inner set of fins 150 can be about 32 mm at a first distal end (i.e., nozzle inlet), and this width can gradually decrease to about 12 mm at an opposite second distal end (i.e., nozzle outlet). In various embodiments, elongated fin thicknesses can vary between 1.5-50 mm, depending on the number of fins used and the number of adjustable fin sets used. As a specific example, the thickness of each elongated fin in inner set of fins 150 can be about 2.5 mm.

Each individual elongated fin in inner set of fins 150 can be coupled to a component from a nozzle actuator arrangement 160. Such components can be one or more fin adjusters 162, which fin adjusters can in turn be coupled to at least one power transmitter 164. Fin adjusters 162 can be configured to adjust the elongated fins to different positions, such as between the closed position and the open position, when power is applied to the power transmitter 164 and during operation of the engine. Fin adjusters 162 and power transmitters 164 can take a variety of forms. For example, each fin adjuster 162 can be a push rod having a first end and a second end. In such arrangements, each push rod can be coupled at its first end to one of the elongated fins and at its second end to the power transmitter 164. Power transmitter 164, which can also be called a driver, can take the form of a single piece star-shaped structure having multiple arms, with each arm being coupled to a push rod or other fin adjuster 162.

In the example arrangement shown, any driving motion applied to star-shaped driver or other power transmitter 164 can in turn move each of the push rods or other fin adjusters 162, which can in turn adjust the elongated fins in every set of fins. In some arrangements multiple power transmitters 164 can be used, such that separate sets of fins or even groups of fins or individual fins can be moved independently from each other via different power transmitters 164 coupled to different sets of fin adjusters 162. In some arrangements, rotational movement of the power transmitter 164 can push or pull the fin adjusters 162, which then in turn move the fins correspondingly. In some arrangements, lateral movement of the power transmitter 164 can also push or pull the fin adjusters 162, which then in turn move the fins correspondingly. For example, such lateral movement can take the form of an inward and outward driving motion of the power transmitter.

As in the case of various exhaust nozzle components above, components of the nozzle actuator arrangement are also subjected to high temperatures and forces. As such, materials used to form the components of nozzle actuator arrangement 160 can include, for example, Inconel, stainless steel, ceramic, or composite materials. Other materials can also similarly be included for additional purposes, such as adding or mixing one or more aluminum items to increase thermal conductivity and thereby increase cooling abilities.

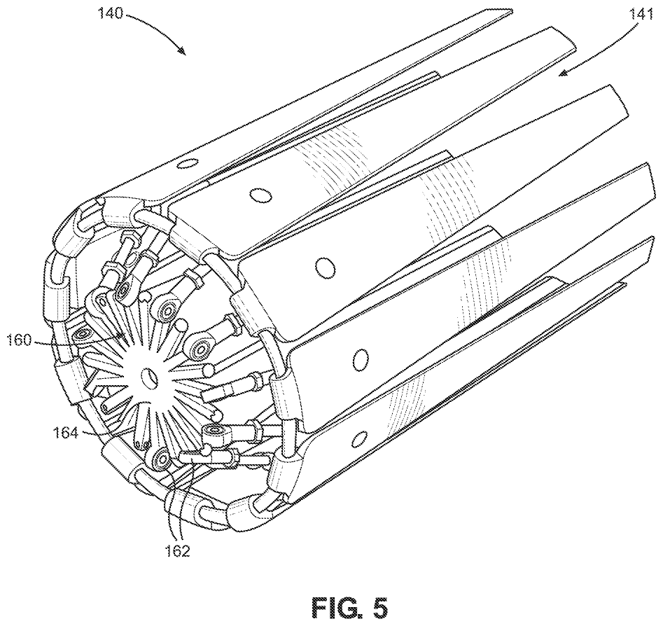

FIG. 5 illustrates in rear perspective view an outer set of adjustable fins and combined nozzle actuator arrangement for the adjustable exhaust nozzle of FIG. 3A. Outer set of fins 140 is similarly shown in fully open or expanded position and can include multiple fins as may be desired for a given design. Gaps 141 between each fin can grow as the outer set of fins expands to a fully open position as shown. In various embodiments, the number of elongated fins can vary between 2 and 36 fins. The number of outer fins can match the number of inner fins (not shown) such that each fin can be arranged to cover a gap between fins in the other set of fins. As a specific example, eleven elongated fins can be used for outer set of fins 140. Resolution of the combined outer structure of the exhaust nozzle and the design of its mechanical infrastructure can be important when choosing the number of elongated fins and the number of sets of fins.

Again, elongated fin lengths can vary between 80-500 mm in various arrangements. As a specific example, the length of each elongated fin in outer set of fins 140 can be about 200 mm. The width of each elongated fin in outer set of fins 140 can also depend on the number of fins, with the width of each fin correspondingly decreasing when more fins are used in a given design. Again, elongated fin widths can vary between 4-250 mm, and each elongated fin in outer set of fins 140 can be tapered, such that the width of each fin decreases from a first distal end located at the exhaust nozzle inlet toward a second distal end located at the exhaust nozzle outlet. As a specific example, the width of each elongated fin in outer set of fins 140 can be about 36 mm at a first distal end (i.e., nozzle inlet), and this width can gradually decrease to about 14.5 mm at an opposite second distal end (i.e., nozzle outlet). Again, elongated fin thicknesses can vary between 1.5-50 mm, depending on the number of fins used and the number of adjustable fin sets used. As a specific example, the thickness of each elongated fin in outer set of fins 150 can also be about 2.5 mm.

Each individual elongated fin in outer set of fins 140 can similarly be coupled to a component from a nozzle actuator arrangement 160. Such components can similarly be one or more fin adjusters 162, which fin adjusters 162 can in turn be coupled to at least one power transmitter 164. Fin adjusters 162 can take the same form, size, and shape, as the fin adjusters for the inner set of fins above or can be varied in any regard as may be desired. Power transmitter 164 can be the same power transmitter used for the inner set of fins above, such that movement of the power transmitter 164 transfers power and causes corresponding movement in all fins from both the inner and outer set of fins. Alternatively, power transmitter 164 for the outer set of fins 140 can be separate from the power transmitter for the inner set of fins 150, such that each set of fins can be driven and moved independently.

Each set of fins can be guided by the same or a separate power transmitter 164 under its own pushing, compression, torsional and buckling forces. These forces can correspondingly move and adjust the fins, and that this movement can be directed according to the design of the fins and the overall nozzle actuator arrangement. Proper movement can cause the thrust of the engine to be directed properly depending on the set angles of each set of fins. In some arrangements, it can be possible to move each elongated fin individually, in groups of fins, in entire sets of fins, or all fins collectively. Separate directional movements of all elongated fins can be possible using components from hydraulic, pneumatic and/or electrical systems. In addition, it can be possible not to move all elongated fins synchronously with each other.

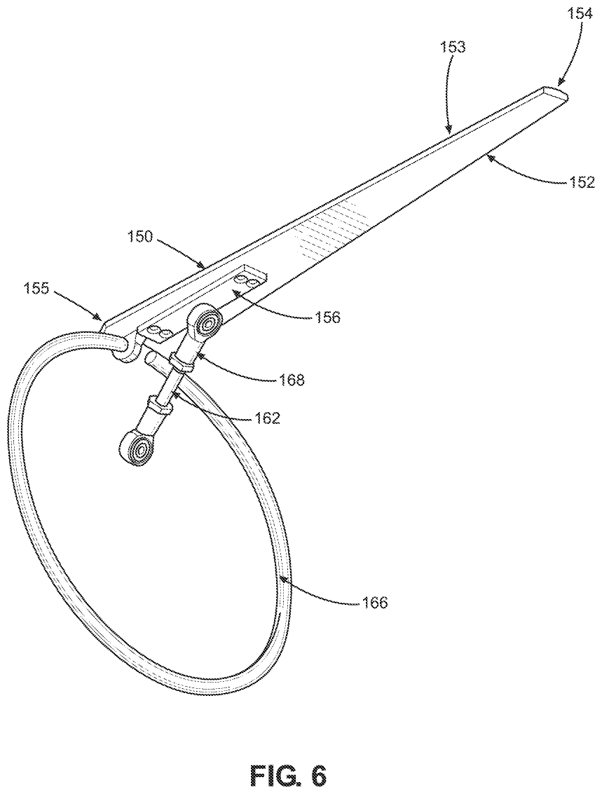

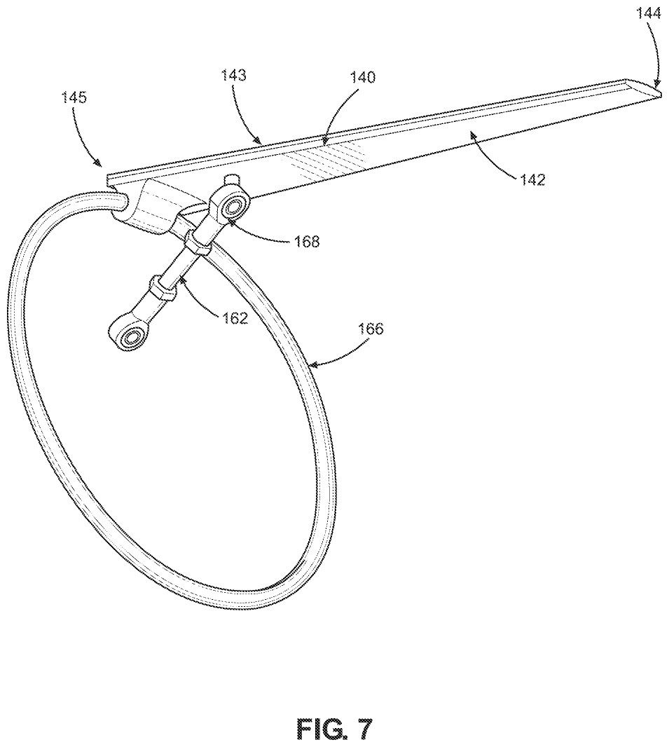

FIG. 6 illustrates in side perspective view a single inner elongated fin 150 and actuator for an adjustable exhaust nozzle, while FIG. 7 illustrates in side perspective view a single outer elongated fin 140 and actuator for an adjustable exhaust nozzle. These single fin and actuator component arrangements can be similar, as shown. Inner elongated fin 150 can have an inner surface 152, outer surface 153, first distal end 154, and second distal end 155. Outer elongated fin 140 can similarly have an inner surface 142, outer surface 143, first distal end 144, and second distal end 145. As noted above, the first distal ends of all fins can combine to define a circular exhaust nozzle outlet, while the second distal ends of all fins can combine to define a circular exhaust nozzle inlet.

Both inner elongated fin 150 and outer elongated fin 140 can be coupled about a connecting ring 166 or other suitable arranging component. As shown, each elongated fin 140, 150 can be coupled to this connecting ring 166 such that a hinged or rotational movement about the connecting ring 166 is possible. As noted above, a power transmitter (not shown) can be driven through any suitable external force as may be desired. Movement of the power transmitter can in turn drive or move push rods or other fin adjusters 162, which can alternatively be hydraulic or pneumatic pistons, for example. Fin adjusters 162 can in turn push or pull the elongated fins 140, 150 in a pivoting fashion about the connecting ring 166. One or more bearings 168 can be used to facilitate connections between the fin adjusters 162 and the elongated fins 140, 150, as well as between the fin adjusters 162 and the power transmitter. Such bearings can be ball bearings, cylindrical, conical or spherical fittings, or any other suitable form of bearing as may be desired. Other coupling mechanisms can be used between the fin adjusters and between the fins and between the fin adjusters and the power transmitter. Such coupling mechanisms can include, screw shafts, springs, couplings and bearings, traditional welds, rivets, bolted nut connections, or ultrasonic welds, among other suitable couplings.

As a specific example, fin adjusters 162 can be push rods and bearings 168 can be ball bearings. The combined length of each push rod and ball bearing combination can be between about 10-250 mm. As a specific example, this combined length can be about 47 mm. The diameter of such push rods can vary from about 5-75 mm depending on the expected loads that each push rod is expected to carry. Again, due to exposure to high temperatures and forces experienced during engine operations, fin adjusters 162, bearings 168, and all other nozzle actuator arrangement components can be formed from materials such as Iconcel, steel, ceramic, aluminum alloy, and/or polymers that are resistant to the effects of high heats and forces.

In various embodiments, the disclosed rotating detonation engines can include one or more sensors and at least one processor. Alternatively, similar components can be associated with the disclosed rotating detonation engines. The sensor(s) can be configured to detect one or more factors relating to engine operation, such as, for example, the altitude of the engine, the ambient air pressure outside the engine, or both. Other things that can be detected by these sensor(s) can include temperature, speed, gravitational force, thrust, and the like. One or more processors can be configured to receive data from the one or more sensors and control the power transmitter automatically in response to the received data. Control of the power transmitter can move the power transmitter rotationally and/or laterally, which in turn can move the fin adjusters, which in turn can contract or expand the fins, which in turn can adjust the diameter of the circular exhaust nozzle outlet according to the detected altitude of the engine, the detected ambient air pressure outside the engine, and/or one or more other factors.

Although the foregoing disclosure has been described in detail by way of illustration and example for purposes of clarity and understanding, it will be recognized that the above described disclosure may be embodied in numerous other specific variations and embodiments without departing from the spirit or essential characteristics of the disclosure. Certain changes and modifications may be practiced, and it is understood that the disclosure is not to be limited by the foregoing details, but rather is to be defined by the scope of the appended claims.

What is claimed is:

1. A rotating detonation engine, comprising:
an annular combustion chamber configured for the repetitive high frequency combustion of fuel and oxidizer reactants, wherein the annular combustion chamber includes an internal region, an exterior, an inlet and an outlet;
an adjustable exhaust nozzle coupled to the outlet of the annular combustion chamber and configured to receive exhaust reactants expelled from the annular combustion chamber, the adjustable exhaust nozzle including a plurality of elongated fins arranged in a conical shape and having inner surfaces, outer surfaces, first distal ends, and second distal ends, the plurality of elongated fins being operable to contract toward a closed position and expand toward an open position, wherein the first distal ends of the elongated fins define a circular exhaust nozzle outlet having a first diameter at the closed position and a second diameter at the open position, the first diameter being smaller than the second diameter; and
a nozzle actuator arrangement coupled to the plurality of elongated fins, the nozzle actuator arrangement including one or more fin adjusters coupled to at least one power transmitter, wherein the one or more fin adjusters are configured to adjust the plurality of elongated fins between the closed position and the open position when power is applied to the at least one power transmitter and during operation of the rotating detonation engine.

2. The rotating detonation engine of claim 1, wherein the plurality of elongated fins includes an inner set of fins located within an outer set of fins.

3. The rotating detonation engine of claim 2, wherein the inner set of fins and outer set of fins contract toward the closed position together and expand toward the open position together.

4. The rotating detonation engine of claim 3, wherein the inner set of fins cover expanding gaps between the outer set of fins when the outer set of fins expands toward the open position.

5. The rotating detonation engine of claim 2, wherein the plurality of elongated fins further includes one or more intermediary sets of fins between the inner set of fins and outer set of fins.

6. The rotating detonation engine of claim 1, wherein the exhaust reactants expelled from the annular combustion chamber follow a flow path along the inner surfaces of the plurality of elongated fins from the annular combustion chamber to the circular exhaust nozzle outlet.

7. The rotating detonation engine of claim 1, wherein the one or more fin adjusters include a plurality of push rods having first ends and second ends.

8. The rotating detonation engine of claim 6, wherein each of the plurality of push rods is coupled at its first end to one of the plurality of elongated fins and at its second end to the at least one power transmitter.

9. The rotating detonation engine of claim 8, wherein the first end of each of the plurality of push rods is coupled to one of the plurality of elongated fins proximate its second distal end.

10. The rotating detonation engine of claim 8, wherein rotational movement of the at least one power transmitter results in corresponding movements in all of the plurality of push rods which results in all of the plurality of fins being collectively contracted or expanded.

11. The rotating detonation engine of claim 8, wherein lateral movement of the at least one power transmitter results in corresponding movements in all of the plurality of push rods which results in all of the plurality of fins being collectively contracted or expanded.

12. The rotating detonation engine of claim 1, wherein the adjustable exhaust nozzle and nozzle actuator arrangement are formed from materials configured to withstand temperatures up to 3000° C. and forces up to 50 kN without deforming.

13. The rotating detonation engine of claim 12, wherein the materials are selected from the group consisting of Iconcel, steel, and ceramic.

14. The rotating detonation engine of claim 1, wherein the plurality of elongated fins are operable to contract or expand toward any position between the closed position the open position to result in a plurality of possible circular exhaust nozzle outlet diameters between the first diameter and the second diameter.

15. The rotating detonation engine of claim 1, further comprising:
one or more sensors configured to detect the altitude of the rotating detonation engine, the ambient air pressure outside the rotating detonation engine, or both; and
at least one processor configured to receive data from the one or more sensors and control the power transmitter in response to the received data, wherein control of the power transmitter adjusts the diameter of the circular exhaust nozzle outlet according to the altitude of the rotating detonation engine, the ambient air pressure outside the rotating detonation engine, or both.

16. An exhaust nozzle configured for use in a detonation engine, the exhaust nozzle comprising:
a circular exhaust nozzle inlet coupled to an outlet of an annular combustion chamber in the detonation engine, the circular exhaust nozzle inlet configured to receive exhaust reactants expelled from the annular combustion chamber;
a circular exhaust nozzle outlet configured to expel exhaust reactants from the exhaust nozzle, wherein expelling the exhaust reactants provides thrust to the detonation engine; and
a plurality of elongated fins arranged in a conical shape and having inner surfaces, outer surfaces, first distal ends, and second distal ends, the plurality of elongated fins being operable to contract toward a closed position and expand toward an open position, wherein the first distal ends of the elongated fins combine to define the circular exhaust nozzle outlet and the second distal ends of the elongated fins combined to define the circular exhaust nozzle inlet, and wherein the circular exhaust nozzle outlet has a first diameter at the closed position and a second diameter at the open position, the first diameter being smaller than the second diameter.

17. The exhaust nozzle of claim 16, wherein the plurality of elongated fins includes an inner set of fins located within an outer set of fins.

18. The exhaust nozzle of claim 17, wherein the inner set of fins and outer set of fins contract toward the closed position together and expand toward the open position together, and wherein the inner set of fins cover expanding gaps between the outer set of fins when the outer set of fins expands toward the open position.

19. The exhaust nozzle of claim 17, wherein the plurality of elongated fins further includes one or more intermediary sets of fins between the inner set of fins and outer set of fins.

20. The exhaust nozzle of claim 16, wherein the exhaust reactants expelled from the annular combustion chamber follow a flow path along the inner surfaces of the plurality of elongated fins from the annular combustion chamber to the circular exhaust nozzle outlet.
